(19) United States
(12) Patent Application Publication
(10) Pub. No.: US 2015/0055015 A1
(43) Pub. Date: Feb. 26, 2015

(54) VIDEO/AUDIO DATA PROCESSING METHOD AND ASSOCIATED MODULE

(71) Applicant: MStar Semiconductor, Inc., Hsinchu Hsien (TW)

(72) Inventors: LING-HSUAN HUANG, Hsinchu Hsien (TW); Hung-Chi HUANG, Hsinchu Hsien (TW)

(21) Appl. No.: 14/467,397

(22) Filed: Aug. 25, 2014

(30) Foreign Application Priority Data
Aug. 23, 2013 (TW) 102130290

(51) Int. Cl. H04N 5/60; H04N 5/45; H04N 5/44

(52) U.S. Cl. CPC H04N 5/607; H04N 5/44; H04N 5/45; H04N 5/602
USPC 348/552

(57) ABSTRACT

A video/audio data processing module is provided. By directly transmitting audio streams of different channels designated by multiple users to mobile devices respectively held by the users, instead of being restricted to a limitation that a digital TV being capable of playing a monophonic audio, the users are enabled to listen to audios of respective desired programs.

This application claims the benefit of Taiwan application Serial No. 102130290, filed Aug. 23, 2013, the subject matter of which is incorporated herein by reference.

### BACKGROUND OF THE INVENTION

1. Field of the Invention

The invention relates in general to a video/audio data processing method and an associated module, and more particularly, to a video/audio data processing method for enabling a digital TV to simultaneously provide a plurality of mobile devices with different audios of different channels for playback, and a module applying the method.

2. Description of the Related Art

A picture-in-picture (PIP) digital TV available on the market, by way of dividing an image on a single screen, supports a function of simultaneously playing images of programs broadcasted by two or more channels. As being capable of playing images of programs broadcasted by different channels, a PIP digital TV, e.g., an outdoor TV wall, usually has a screen that is larger than a household TV.

However, although a common PIP digital TV is capable of simultaneously playing images of multiple programs, audios of these programs cannot be played simultaneously as well. In other words, in a common PIP digital TV, an audio stream of one of the programs is monophonically played. Thus, when multiple users are viewing images of different programs played on a same PIP TV, only the user viewing the main picture is allowed to listen the audio of the program corresponding to the main picture, while the users of the remaining sub pictures can only view the images of the programs without the corresponding audios.

### SUMMARY OF THE INVENTION

The invention is directed to a video/audio data processing method and an associated module for overcoming an issue of the prior art, in which a PIP digital TV is capable of playing only an audio of one single channel instead of simultaneously playing audios of other channels.

A video/audio data processing method applied to a digital TV is disclosed by the present invention. The digital TV is configured to simultaneously play a plurality of videos on a screen. The method includes: receiving a plurality of selection instructions, each of the selection instructions being sent out by a device and for selecting one of a plurality of channels; decoding source data to obtain video data and audio data corresponding to the selected channels respectively; playing the video data corresponding to the selected channels on the screen simultaneously; and transmitting the audio data corresponding to the selected channels to the devices respectively.

A video/audio data processing module applied to a digital TV is disclosed by the present invention. The digital TV is configured to simultaneously play a plurality of videos on a screen. The module includes a control module, a decoder and a data transmission module. The control module generates a first control signal and a second control signal according to a plurality of selection instructions. Each of the selection instructions is sent out by a device, and is for selecting one of a plurality of channels. The decoder decodes source data to obtain video data and audio data corresponding to the selected channels respectively, and outputs the video data corresponding to the selected channels for playback on the screen simultaneously. The data transmission module transmits the audio data corresponding to the selected channels to the devices respectively.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a module according to an embodiment of the present invention transmitting audio streams to a plurality of mobile devices; and

FIG. 2 is a flowchart of a video/audio data processing method according to an embodiment of the present invention.

### DETAILED DESCRIPTION OF THE INVENTION

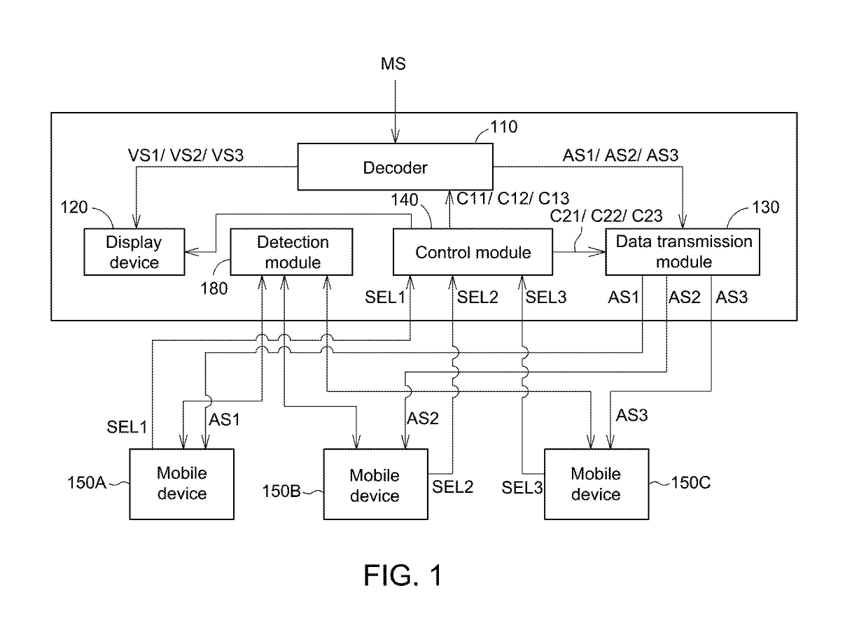

FIG. 1 shows a block diagram of a video/audio data processing module 100 according to an embodiment of the present invention transmitting audio streams in form of sub audio streams to a plurality of mobile devices 150A, 150B and 150C. The module 100 is applied to a digital TV, which is capable of simultaneously displaying a plurality of sub pictures.

The module 100 includes a decoder 110, a display device, 120, a data transmission module 130, a control module 140, and a detection module 180.

The detection module 180 assists the module 100 to detect mobile devices within a detection range of the digital TV. In this example, the mobile devices 150A, 150B and 150C are detected. The detection module 180 further establishes network connections between the control module 140 and the mobile devices 150A, 150B and 150C, and network connections between the data transmission module 130 and the mobile devices 150A, 150B and 150C. For example, the network connections may be established through wired or wireless means.

The control module 140 receives selection instructions SEL1, SEL2 and SEL3 from the mobile devices 150A, 150B and 150C through wired or wireless means, respectively, and generates a first control signal and a second control signal for each of the selection instructions SEL1, SEL2 and SEL3. The first control signal is transmitted by the control module 140 to the decoder 110 to instruct the decoder 110 on a decoding method to be performed. The second instruction signal is transmitted by the control module 140 to the data transmission module 130 to instruct the data transmission module 130 on data transmission method to be performed. Each of the selection instructions SEL1, SEL2 and SEL3 is for selecting one of a plurality of channels. Taking FIG. 1 for example, the control module 140 generates a first control signal C11 and a second control signal C12 corresponding to the selection instruction SEL1, a first control signal C21 and a second control signal C22 corresponding to the selection instruction SEL2, and a first control signal C31 and a second control signal C32 corresponding to the selection instruction SEL3. In one embodiment, the control module 140 further changes a configuration that the display device 120 displays the sub pictures according to a configuration setting designated by the selection instructions SEL1, SEL2 and SEL3.

According to a channel instructed by the first control signal, the decoder 110 decodes a multimedia data stream MS that the module 100 receives from an external multimedia stream source to obtain a corresponding video stream and audio stream. Taking FIG. 1 for example, the decoder 110 decodes the multimedia data stream MS to obtain a corresponding video stream VS1 and audio stream AS1 of a first channel as instructed by the first control signal C11, a corresponding video stream VS2 and audio stream AS2 of a second channel instructed as by the first control signal C12, and a corresponding video stream VS3 and audio stream AS3 of a third channel as instructed by the first control signal C13. The decoder 110 further transmits the video streams VS1, VS2 and VS3 obtained from decoding to the display device 120, and transmits the audio streams AS1, AS2 and AS3 obtained from decoding to the data transmission module 130.

The display device 120 plays program images of channels respectively corresponding to the video streams VS1, VS2 and VS3 in sub pictures according to a PIP configuration setting. The PIP configuration setting may be designated by the selection instructions SEL1, SEL2 and SEL3.

The data transmission module 130 transmits the audio streams AS1, AS2 and AS3 to the mobile devices 150A, 150B and 150C by wired or wireless means, respectively, so that the users of the mobile devices 150A, 150B and 150C are enabled to select the sub audio streams of the channels as desired.

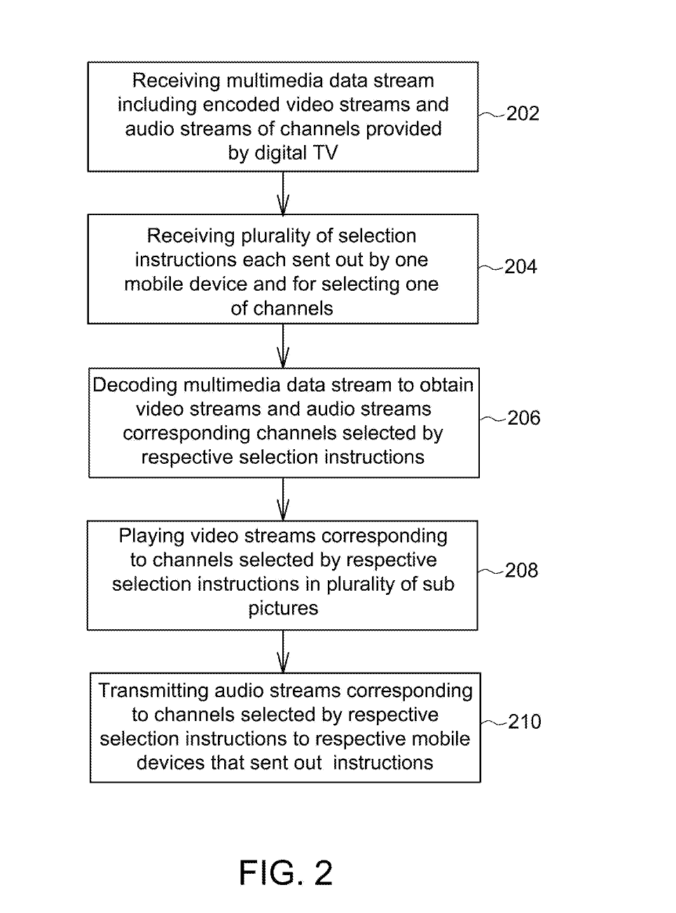

FIG. 2 shows a flowchart of a video/audio data processing method applied to a digital TV according to an embodiment of the present invention. The method is applied to the module 100 in FIG. 1, and includes the following steps, as shown in FIG. 2.

In step 202, a multimedia data stream MS is received. The multimedia data stream MS includes encoded video streams and audio streams of a plurality channels.

In step 204, a plurality of selection instructions SEL1, SEL2 and SEL3 are received. Each of the selection instructions SEL1, SEL2 and SEL3 is sent out by a mobile device and is for selecting one of the channels.

In step 206, the multimedia data stream MS is decoded to obtain the video streams and the audio streams corresponding to the channels selected by the respective selection instructions.

In step 208, the video streams of the channels selected by the respective selection instructions are played in a plurality of sub pictures.

In step 210, the audio streams AS1, AS2 and AS3 corresponding to the channels selected by the respectively signals SEL1, SEL2 and SEL3 are transmitted to the respective mobile devices 150A, 150B and 150C that sent out the selection instructions SEL1, SEL2 and SEL3.

In step 202, the decoder 110 receives the multimedia data stream MS from an external multimedia stream source.

In step 204, the control module 140 selects one of the channels according to the selection instructions SEL1, SEL2 and SEL3 of the respective mobile devices 150A, 1508 and 150C.

In step 206, the decoder 110 decodes the multimedia data stream MS to obtain the video streams VS1, VS2 and VS3 and the audio streams AS1, AS2 and AS3 corresponding to the channels designated by the respective selection instructions SEL1 SEL2 and SEL3.

In step 208, the display device 120 generates a plurality of sub pictures according to a PIP configuration setting designated by the selection instruction SEL1, SEL2 or SEL3, and plays contents of the video streams VS1, VS2 and VS3 in the respective sub pictures. In one embodiment, the PIP configuration setting that the selection instructions SEL1, SEL2 and SEL3 respectively utilize to designate sub pictures of the display device 120 includes a size ratio, relative positions, an arrangement combination and shapes of the sub pictures.

In step 210, the data transmission module 130 transmits the audio streams AS1, AS2 and AS3 to the mobile devices 150A, 150B and 150C according to the respective selection instructions SEL1, SEL2 and SEL3. Accordingly, the mobile device 150A may play the received audio stream AS1, the mobile device 150B may play the received audio stream AS2, and the mobile device 150C may play the received audio stream AS3.

With the method in FIG. 2, the users of the mobile devices 150A, 150B and 150C are enabled to simultaneously watch desired programs on the display device 120 and directly listen to program audios of the sub audio streams AS1, AS2 and AS3 on the respective mobile devices 150A, 1508 and 150C without being interfered by one another.

As such, the method in FIG. 2 overcomes the issue of the prior art, in which program audios of different channels desired by multiple users cannot be played by the monophonic function when a digital TV plays PIP images.

It should be noted that, reasonable arrangements and combinations, and/or variations to details of the embodiments of the applications made by one skilled person in the art are to be included within the scope of the present invention.

In the video/audio data processing method and the module applying the method, by directly transmitting audio streams of different channels designated by multiple users to mobile devices respectively held by the users, instead of being restricted to a limitation that a digital TV being capable of playing a monophonic audio, the users are enabled to listen to audios of respective desired programs.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video/audio data processing method, applied to a digital TV, the digital TV configured to simultaneously play a plurality of videos on a screen, the method comprising:
receiving a plurality of selection instructions, each of the selection instructions being sent out by a device and for selecting one of a plurality of channels;
decoding source data to obtain video data and audio data corresponding to the selected channels respectively;
playing the video data corresponding to the selected channels on the screen simultaneously; and
transmitting the audio data corresponding to the selected channels to the devices respectively.

2. The method according to claim 1, further comprising:
detecting the devices within a detection range of the digital TV; and
establishing a connection between the digital TV and the devices.

3. The method according to claim 1, wherein the videos are played in a plurality of areas on the screen respectively, the method further comprising:
setting a configuration of the areas according to the selection instructions.

4. The method according to claim 1, wherein the digital TV is one of the devices.

5. A video/audio data processing module, applied to a digital TV, the digital TV configured to simultaneously play a plurality of videos on a screen, the module comprising:
a control module, configured to generate a first control signal and a second control signal according to a plurality of selection instructions, each of the selection instructions being sent out by a device and for selecting one of a plurality of channels;
a decoder, configured to decode source data to obtain video data and audio data corresponding to the selected channels respectively, and to output the video data corresponding to the selected channels for playback on the screen simultaneously; and
a data transmission module, configured to transmit the audio data corresponding to the selected channels to the devices respectively.

6. The module according to claim 5, further comprising:
a detection module, configured to detect the devices within a detection range of the digital TV and to establish a connection between the control module and the devices.

7. The module according to claim 5, further comprising:
a detection module, configured to detect the devices within a detection range of the digital TV and to establish a connection between the data transmission module and the devices.

8. The module according to claim 5, wherein the videos are played in a plurality of areas on the screen respectively, the control module sets a configuration of the areas according to the selection instructions.

9. The method according to claim 5, wherein the digital TV is one of the devices.
